(19) United States
(12) Patent Application Publication
(10) Pub. No.: US 2024/0034199 A1
(43) Pub. Date: Feb. 1, 2024

(54) SYSTEM FOR LOCKING A CONTINUOUS-ADJUSTMENT SLIDE

(71) Applicant: FAURECIA Sièges d'Automobile, NANTERRE (FR)

(72) Inventors: Fabrice PETIT, FLERS (FR); Vincent NARDIN, ST GEORGES DES GROSEILLIERS (FR); Olivier KIRCHER, FLERS (FR)

(21) Appl. No.: 18/225,948

(22) Filed: Jul. 25, 2023

(30) Foreign Application Priority Data
Jul. 26, 2022 (FR) 2207697

(51) Int. Cl. B60N 2/08

(52) U.S. Cl. CPC B60N 2/0812

(57) ABSTRACT

A system for locking at least one continuous-adjustment slide for a vehicle seat, comprising; the at least one slide, an over-center locking system comprising: a rail, fixed relative to the first slide element, resilient means generating return forces configured to provide a switchover to locking of a first locking member so as to provide an over-center of the first locking member on the rail and a switchover to locking of a second locking member providing an over-center of the second locking member on the rail. According to the present disclosure, an unlocking mechanism comprises an electric actuator and a transmission configured to provide the switchover to unlocking of the first locking member and the switchover to unlocking of the second locking member, against the return forces of the resilient means.

### PRIORITY CLAIM

This application claims priority to French Patent Application No. FR2207697, filed Jul. 26, 2022, which is expressly incorporated by reference herein.

### BACKGROUND

The present disclosure relates to a system for locking a slide for a continuous-adjustment vehicle seat, as well as to a vehicle seat comprising such a locking system.

### SUMMARY

According to the present disclosure, a system for locking at least one continuous-adjustment slide for a vehicle seat comprises:
the at least one slide, in particular a first slide and a second slide, parallel to each other, the at least one slide, in particular the first slide or the second slide, comprising a first, lower slide element configured to be fastened to a floor of the vehicle, and a second, upper slide element configured to slide along the first slide element
an over-center locking system comprising:
   a rail, extending lengthwise along the at least one slide, fixed relative to the first slide element, the rail having a first, upper friction surface and a second, opposite, lower friction surface
   a first locking member and a second locking member, mounted rigidly connected to the second slide element, with positions offset along a longitudinal axis of the rail, the first locking member comprising a first wall and a second wall, facing each other, configured to rub on the first friction surface and second friction surface of the rail, respectively, the second locking member comprising a third wall and a fourth wall, facing each other, configured to rub on the first friction surface and second friction surface of the rail,
resilient means generating return forces configured to provide:
   a switchover to the locking of the first locking member so as to provide an over-center of the first locking member on the rail providing a locking of the second slide element relative to the first slide element in a first sliding direction, by two reactions of the rail on the first locking member, with on the one hand a first reaction between the first upper friction surface of the rail and the first wall of the first locking member and, on the other hand, a second reaction between the second lower friction surface of the rail and the second wall of the first locking member,
   a switchover to the locking of the second locking member providing an over-center of the second locking member on the rail providing a locking of the second slide element relative to the first slide element in a second sliding direction, by two reactions of the rail on the second locking member, with on the one hand a third reaction between a first upper friction surface of the rail and the third wall of the second locking member and, on the other hand, a fourth reaction between the second lower friction surface of the rail and the fourth wall of the second locking member,
an unlocking mechanism which is configured to drive, on the one hand, a switchover to the unlocking of the first locking member releasing the slide so it may slide in the direction S1, and on the other hand, a switchover to the unlocking of the second locking member releasing the slide so it may slide in the direction S2.

In illustrative embodiments, the unlocking mechanism comprises an electric actuator and a transmission coupled to the actuator, the electric actuator and the transmission being configured to provide the switchover of the first locking member and the switchover to the unlocking of the second locking member, against the return forces of the resilient means.

The features disclosed in the following paragraphs may optionally be implemented. They can be implemented independently of one another or in combination with one another:
the first slide element is a lower profile and the second slide element is an upper profile, slidably mounted along the lower profile, the first locking member and the second locking member extending internally in the interspace between the upper profile and the lower profile, the rail rigidly connected to the lower profile, accommodated in the interspace, and if necessary the first locking member (and the second locking member protrudes from the upper profile through at least one opening of the upper profile;
the electric actuator is embedded on the movable upper profile, outside the interspace between the upper profile and the lower profile, preferably the lower profile having a section with a base extending substantially along a plane parallel to the plane XY, extended by one or even two upward wings and the upper profile, having a section, with a main wing extending substantially along a plane parallel to the plane XY, extended by two downward wings and wherein the electric actuator is arranged above the main wing;
the electric actuator comprises a first part fixed relative to the upper profile and a part translationally movable relative to the fixed part, connected to the transmission, and wherein the movable part is translationally movable in a direction which is, for example, parallel to the sliding direction of the slide, or a direction inclined relative to the sliding direction, for example by plus or minus 15°, in particular around a transverse direction Y;
the transmission comprises a control bar, rigidly connected to the upper slide profile of the at least one slide, rotatably mounted about an axis of rotation of the control bar in a direction Y transverse to the at least one slide, preferably the control bar (BAR) connecting the upper profiles (of the two slides by synchronizing the unlocking of the first locking member and of the second internal locking member, both within the interspace of the upper and lower profiles of the first slide, on the one hand, and the unlocking of the first locking member and of the second internal locking member, both within the interspace of the upper and lower profiles of the second slide, on the other hand, when the at least one slide comprises the two slides consisting of the first slide and the second slide;
the translationally movable part of the electric actuator is connected to the control bar by means of a lever extending radially to the control bar, the lever constrained to rotate with the control bar, the movable part and the lever being connected by an axis rigidly connected to the movable part, configured to move along a limited stroke, within an oblong hole of the lever, to provide the rotation of the lever relative to the upper profile of the at least one slide during the translation of the movable part;
the movable part having a fork comprising a first branch and a second branch between which the lever is inserted, the axis connecting the first branch and the second branch, passing through the oblong hole of the lever;
the at least one slide comprises the first slide and the second slide, the control connecting the upper profiles of the two slides by synchronizing the unlocking of the first and second locking members within the interspace of the upper and lower profiles of the first slide, on the one hand, and the unlocking of the first and second locking members within the interspace of the upper and lower profiles of the second slide, on the other hand, the actuator being a single actuator rigidly connected to the upper profile of the first slide or rigidly connected to the second slide configured to provide the unlocking of the locking members of the two slides consisting of the first slide and second slide via the control bar;
the system is configured so that the work provided by the electric actuator to provide the switchover of the first and second locking members of the at least one slide to being locked is less than 0.1 joule per slide, in particular less than 0.2 joule to provide the simultaneous switchover of the first and second locking members associated with the first slide and the second slide. This allows the use of an actuator that is not very powerful, for example a rated power of less than 10 watts, or even rated power less than 5 watts.

According to a second aspect, the present disclosure relates to a vehicle seat comprising a squab and a backrest as well as a continuous-adjustment locking system according to the present disclosure, the first slide element of which is anchored to a floor of the vehicle and the second slide element of which is rigidly connected to a chassis of the squab.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a system for locking at least one continuous-adjustment slide comprising a first slide (left) and a second slide (right), each comprising: on the one hand, a first lower slide element, formed by a lower profile, and a second upper slide element, formed by an upper profile, and on the other hand: an over-center locking system comprising: a rail, extending lengthwise along the at least one slide, stationary relative to the first slide element, a first locking member and a second locking member, mounted rigidly connected to the second slide element, with positions offset along a longitudinal axis of the rail, resilient means generating return forces configured to provide, on the one hand, a switchover to the locking of the first locking member so as to provide an over-center of the first locking member on the rail providing a locking of the second slide element relative to the first slide element in a first direction 51, and on the other hand, a switchover to the locking of the second locking member providing an over-center of the second locking member on the rail providing a locking of the second slide element relative to the first slide element in a second sliding direction S2, an unlocking mechanism which is configured to drive, on the one hand, a switchover to the unlocking of the first locking member freeing the slide so that it may slide in the direction S1, and on the other hand, a switchover to the unlocking of the second locking member freeing the slide so that it may slide in the direction S2, the mechanism comprising an electric actuator and a transmission coupled to the actuator, the electric actuator and the transmission being configured to provide the switchover to the unlocking of the first locking member and the switchover to the unlocking of the second locking member, against the return forces of the resilient means belonging to the two slides, right and left, the actuator comprising a fixed part rigidly connected to the second sliding element (right, as shown by way of example) and a translationally movable part that is coupled to a control lever extending radially from a control shaft connecting the upper profiles of the first and second sliders, the shaft extending longitudinally in a transverse direction Y.

FIG. 2 is a detail view of the actuator that comprises a fixed part rigidly connected to the upper profile of the slide (right), the fixed part housing a motor, in particular a geared motor, and a part translationally movable in a direction parallel to the sliding direction, connected by a fork at a distal end of the control lever, the proximal end of the lever being rotationally coupled to the control bar.

FIG. 2A is a sectional view of the system along a cutting plane parallel to the plane XZ, therefore perpendicular to the transverse bar, the plane passing through the lever, showing, on the one hand: the connection between the movable part and the lever, which comprises an oblong hole extending along the control lever, and an axis of the movable part, passing through the oblong hole, the connection between the control bar and the lever, which comprises a notably striated circumference of the control bar, and a ring of the proximal end of the control lever, crossed by the control lever, the ring engaging the circumference of the control bar, the ring comprising a tapped bore, oriented radially to the bar, for a clamping screw providing the locking of the position of the ring on the control bar.

FIG. 2B is a sectional view taken along a horizontal plane passing through the distal end of the lever at the connection between a fork of the movable part of the actuator, on the one hand, and the distal end, and which comprises the axis extending transversely between the two branches of the fork, the axis passing through the oblong hole of the lever.

FIG. 3 is a sectional view along a plane XZ passing through a slide, showing the rail rigidly connected to the lower profile of the slide, and the first locking member and the second locking member rigidly connected to the upper slide profile.

FIG. 4 is a view along a cutting plane close to that of FIG. 3, showing a gear of the transmission, comprising a first toothed section internal to the slide, constrained to rotate with the control bar, meshing with a toothed pinion rigidly connected to an unlocking cam.

FIG. 5 is a view along a cutting plane close to that of FIG. 4, showing the unlocking cam, in a first position allowing the locking of the first and second locking member, constrained to switch the resilient means into their locking position, the cam configured to be pivoted by the actuator and the transmission to a position providing the switchover of the first and second locking member of the slide.

FIG. 6 is an embodiment of the present disclosure according to a first embodiment of the over-center conditions of the first and second locking members on the rail.

FIG. 7 is an embodiment of the present disclosure according to a second embodiment of the over-center conditions of the first and second locking members on the rail, as an alternative example to that of FIG. 6.

### DETAILED DESCRIPTION

In the figures, the orthogonal reference frame XYZ is oriented so that the axis X is oriented along the sliding axis of the slide, the direction Y in the horizontal direction, transverse to the slide, perpendicular to X, and the axis Z along the vertical.

Also, the present disclosure relates to a system 1 for locking at least one continuous-adjustment slide for a vehicle seat, comprising;
the at least one slide 2, in particular a first slide 2a and a second slide 2b, parallel to each other, the at least one slide, in particular the first slide or/or the second slide, comprising a first, lower slide element 20 configured to be fastened to a floor of the vehicle, and a second, upper slide element 21 configured to slide along the first slide element
an over-center locking system comprising:
   a rail 3, extending lengthwise along the at least one slide, potentially the first slide 2a or the second slide, fixed relative to the first slide element, the rail having a first, upper friction surface 30 and a second, opposite, lower friction surface 31
   a first locking member 4 and a second locking member 5, mounted rigidly connected to the second slide element 21, with positions offset along a longitudinal axis of the rail 3, the first locking member 4 comprising a first wall 40 and a second wall 41, facing each other, configured to rub on the first friction surface 30 and second friction surface 31 of the rail, respectively, the second locking member 5 comprising a third wall 50 and a fourth wall 51, facing each other, configured to rub on the first friction surface 30 and second friction surface 31 of the rail 3.

The locking system 1 further comprises resilient means generating return forces configured to provide:
a switchover to the locking of the first locking member 4 so as to provide an over-center of the first locking member 4 on the rail 3 providing a locking of the second slide element relative to the first slide element in a first sliding direction S1, by two reactions of the rail on the first locking member, with on the one hand a first reaction RA1 between the first upper friction surface 30 of the rail and the first wall 40 of the first locking member 4 and, on the other hand, a second reaction RB1 between the second lower friction surface 31 of the rail and the second wall 41 of the first locking member 4,
a switchover to the locking of the second locking member 5 providing an over-center of the second locking member 5 on the rail 3 providing a locking of the second slide element 21 relative to the first slide element 20 in a second sliding direction S2, by two reactions of the rail on the second locking member, with on the one hand a third reaction RA2 between the first upper friction surface 30 of the rail and the third wall 5 of the second locking member 5 and, on the other hand, a fourth reaction RB2 between the second lower friction surface 31 of the rail and the fourth wall 51 of the second locking member 5.

The system further comprises an unlocking mechanism 6 which is configured to drive, on the one hand, a switchover to the unlocking of the first locking member 4 releasing the slide so it may slide in the direction 51, and on the other hand, a switchover to the unlocking of the second locking member 5 releasing the slide so it may slide in the direction S2.

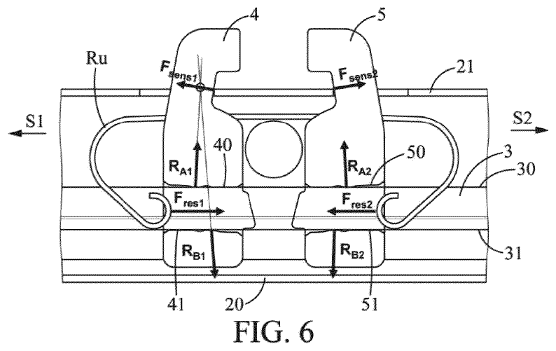

FIG. 6 shows a first possible embodiment of the over-center conditions for which the system comprises the first slide element 20, which is fixed, and the second slide element 21, as well as the rail 3 rigidly connected to the fixed first slide element, as well as the two locking members, the first locking member 4 and second locking member 5, which can switch from a first relative position (separated) allowing the slide to freely slide to a second position (brought closer by the resilient means, typically a spring element Ru in FIG. 6), providing the locking of the slide.

FIG. 6 shows the second relative position between the first locking member 4 and the second locking member 5 that comes in over-center position on the rail 3, under the action of spring element Ru generating a force Fᵣₑₛ₁ on the first locking member 4, and generating a force Fᵣₑₛ₂ on the second locking member 4 tending to bring the first locking member 4 and the second locking member 5 closer together under over-center conditions on the rail, generating:
a first force Fₛₑₙₛ₁ generated by a first abutment of the second slide part 21 on the first locking member 4 providing an over-center of the first locking member 4 on the rail 3 providing a locking of the second, upper slide element 21 relative to the first, lower slide element 20 in a first sliding direction S1, by two reactions of the rail on the first locking member, with on the one hand a first reaction R_{A1} between a first upper friction surface of the rail and a first wall of the first friction member and, on the other hand, a second reaction R_{B1} between a second lower friction surface of the rail and a second wall of the first locking member,
a second force Fₛₑₙₛ₂ generated by the second abutment on the second locking member 5 provides an over-center of the second locking member 5 on the rail 3 while locking the second slide element relative to the first slide element in a second sliding direction S2, by two reactions of the rail on the second locking member 5, with on the one hand a third reaction R_{A2} between a first upper friction surface of the rail and the third wall of the second friction member and, on the other hand, a fourth reaction R_{B2} between the second lower friction surface of the rail and the fourth wall of the second locking member.

Depending on such over-center conditions, the switchover of the locking of the first locking member 4 and of the second locking member 5 are achieved by separating the first locking member 4 and the second locking member from each other, along the sliding direction, and for example by means of an unlocking member 60, which takes the form of a pivoting unlocking cam inserted between the two locking members 4, 5 and such as for example according to the embodiment of FIG. 5.

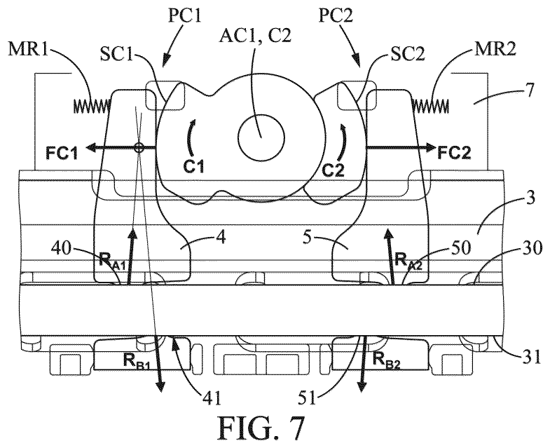

FIG. 7 shows a second possible embodiment of the over-center conditions: the locking system comprises in a totally independent manner two cams, with a first cam C1, and a second cam C2, rigidly connected to the second slide element 21, mounted for example pivotably on a support 7.

First resilient means (not shown) are configured to move the first cam C1, typically in rotation, to provide contact with the first locking member 4 by generating a first force FC1 between the first locking member 4 and the first cam C1 providing an over-center of the first locking member 4 on the rail 3 providing a locking of the second slide element relative to the first slide element in a first sliding direction S1, by two reactions of the rail on the first locking member, with on the one hand a first reaction R_{A1} between the first upper friction surface 30 of the rail and the first wall 40 of the first locking member 4 and, on the other hand, a second reaction R_{B1} between the second lower friction surface 31 of the rail and the second wall 41 of the first locking member 4.

Second resilient means (not shown) are configured to move the second cam C2, typically in rotation, to provide contact with the second locking member 5 by generating a second force FC2 between the second locking member 5 and the second cam C2 providing an over-center of the second locking member 5 on the rail 3 providing a locking of the second slide element 21 relative to the first slide element 20 in a first sliding direction S2, by two reactions of the rail on the second locking member, with on the one hand a third reaction R_{A2} between the first upper friction surface 30 of the rail and the third wall 50 of the second locking member and, on the other hand, a fourth reaction R_{B2} between the second lower friction surface 31 of the rail and the fourth wall 51 of the second locking member 5.

Such an embodiment is advantageous in particular relative to that of FIG. 6, in that the first cam C1 and the second cam C3 can be configured to, during a longitudinal stress on the second slide element generating a micro-movement between the second slide element and the first slide element, still providing the first force FC1 and the second force FC2 providing the over-center of the first locking member and of the second locking member 45, by allowing compensations by moving one of the two cams, or even both cams, the first cam and/or respectively the second cam, by changing the point of contact between the cam and the locking member that is the first locking member or respectively the second locking member, while the other cam, the second cam or respectively first cam, can remain immobile while retaining the contact point between the cam and the locking member that is the first locking member or respectively the second locking member.

In other words, the first cam C1 and second cam C2 can perform, independently of each other, respectively a first compensation on the first locking member 4 and/or a second compensation on the second locking member 5 as a function of the longitudinal stresses and in particular of their direction.

In general, the first cam C1 and the second cam C2 can be articulated on a support 7 rigidly connected to the second element, the movable slide 21, the first cam C1 and the second cam C2 configured to pivot independently, on the support under the action of the first and second resilient means.

The first cam C1 may comprise an eccentric first cam surface SC1, configured to come into contact with the first locking element 4, with an increasing radius between the pivot center of the first cam C1, and the point of contact with the first locking element 4, during pivoting according to the direction of rotation imposed by the first resilient means.

The second cam C2 may comprise an eccentric second cam surface SC2, configured to come into contact with the second locking element 4, with an increasing radius between the pivot center of the second cam C2, and the point of contact with the first locking element 5, during pivoting according to the direction of rotation imposed by the second resilient means.

The first cam C1 and the second cam C2 can be articulated to the support, sharing the same pivot axis AC1C2 extending in a transverse direction. Such an embodiment is advantageous in terms of compactness (along the longitudinal direction X). The first resilient means and the second resilient means may further comprise a same spring member connecting the first cam C1 and the second cam C2, such as a torsion spring.

According to such an embodiment, the unlocking mechanism 6 is configured to drive the movement of the first cam C1 and the movement of the second cam C2 from their positions constrained by the first and second resilient means providing the over-center of the first locking member 4 and of the second locking member 5 on the rail and thus the locking of the slide and to a retracted position of the first cam C1 and a retracted position of the second cam C2 eliminating the over-centers of the first locking member and the second member on the rail, freeing the slide so that it may slide.

In FIG. 7, the arrows associated with the first and second cams indicate the directions of rotation of the cams, imposed by the resilient means, in particular first means and second resilient means, causing the locking of the slide. The unlocking is therefore achieved by a movement of the first cam C1 and a movement of the second cam C2, respectively in opposite directions of rotation.

The system according to this second embodiment can further comprise:
first spring means MR1 between the second slide element 21 and the first locking member 4 so that the first locking member 4 is always in contact with the first cam 4 even in the retracted position of the first cam C1 freeing the slide so that it may slide, and
second spring means MR2 between the second slide element 21 and the second locking member 5 so that the second locking member 5 is always in contact with the second cam C2 even in the retracted position of the second cam C2 freeing the slide so that it may slide.

As a result, the contacts between, on the one hand, the first cam C1 and the first locking element 4, and on the other hand, between the second cam C2 and the second locking element 5 are never lost, over time, from locking/unlocking the slide.

According to the present disclosure, in particular that it is in particular the first embodiment of FIG. 6 or the second embodiment of FIG. 7, the unlocking mechanism 6 comprises an electric actuator AT and a transmission TR coupled to the actuator AT.

The electric actuator AT and the transmission are configured to provide the pivoting of the first locking member 4 and the switchover 5 to unlocking the second locking member 5, against the return forces of the resilient means, and in particular the first and second resilient means associated with the first and second cams C2 as regards the second embodiment.

The electric actuator AT and the transmission TR can also be configured to provide the reverse movement, in order to allow the resilient means to be again cause the locking of the first locking member 4 and the switchover of the second locking member 5 to being locked. In general, the actuator AT may comprise a motor comprising a stator and a rotor, or even typically a reducer, connected to the rotor.

The first slide element 20 may be a lower profile PINF and the second slide element 21 may be an upper profile PSUP, slidably mounted along the lower profile PINF.

In general, the first locking member 4 and the second locking member 5 can extend internally into the interspace between the upper profile PSUP and the lower profile PINF, the rail 3 rigidly connected to the lower profile PINF, accommodated in the interspace, and if applicable the first locking member 4 and the second locking member 5 protrude from the upper profile through at least one opening Ov of the upper profile PSUP.

In general, the electric actuator AT can be embedded on the movable upper profile SUP, outside the interspace between the upper profile SUP and the lower profile INF.

In general, the lower profile PINF may have a section with a base 200 extending substantially along a plane parallel to the plane XY, extended by one or even two upward wings 201, 202 and the upper profile PSUP, having a section, with a main wing 210 extending substantially along a plane parallel to the plane XY, extended by two downward wings 211, 212. The electric actuator AT can be arranged to be greater than the main wing 210.

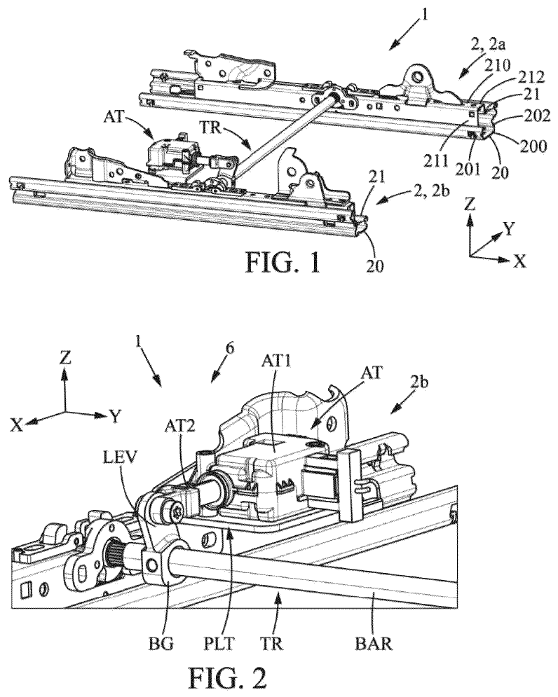

A plate PLT can provide the fastening of the actuator AT on the upper profile PCT of the at least one slide 2, in particular on the first slide 2a or the second slide 2b, as shown by way of example in FIG. 1.

The plate can be a bracket, which comprises a first wing attached to a downward wing 211 of the upper profile PSUP and a second wing, perpendicular to the first wing, forming a horizontal support surface for a fixed part AT1 of the actuator AT.

In general, the plate PLT makes it possible to position the actuator AT, cantilevered, from the upper profile PSUP of the slide along the transverse direction Y, in particular from the first slide 2a or from the second slide 2b. The actuator AT is then typically inserted between the first slide 2a and the second slide 2b, along the transverse direction Y.

The electric actuator AT may comprise a fixed first part AT1 relative to the upper profile PSUP and a movable part AT2, in translation relative to the fixed part AT1, connected to the transmission. When the fixed part AT1 comprises a motor with a stator and a rotor, or even a reducer, typically a gear-based one, the actuator may comprise means for transforming the rotational movement of the rotor, or even the rotational movement of the output of the reducer into a translational movement of the movable part AT2. Such means may comprise, by way of example, a screw-nut system, a rack/pinion gear or the like.

The movable part AT2 is translationally movable typically along a direction which is, for example, parallel to the sliding direction X of the slide, or one along a direction inclined relative to the sliding direction, for example by plus or minus 15°, in particular around a transverse direction Y.

The transmission can comprise a control bar BAR, rigidly connected to the upper slide profile PUSP of the at least one slide, rotatably mounted about an axis of rotation of the control bar BAR in a transverse direction Y to the at least one slide 2.

Preferably, the control bar BAR connects the upper profiles PUSP of the two slides by synchronizing the unlocking of the first member 4 and second locking member 5 inside the interspace of the upper and lower profiles of the first slide 2a, on the one hand, and the unlocking of the first locking member 4 and second locking member 5 inside the interspace of the upper and lower profiles of the second slide 2b, on the other hand.

The actuator AT is preferably a single actuator rigidly connected to the upper profile of the first slide 2a (or rigidly connected to the second slide 2b) configured to provide the unlocking of the locking members (first and second locking member 4,5) of the two slides consisting of the first slide 2a and the second slide 2b via the control bar.

The translationally movable part AT2 of the electric actuator can be connected to the control bar BAR by means of a lever LEV extending to the control bar BAR preferably in a radial direction.

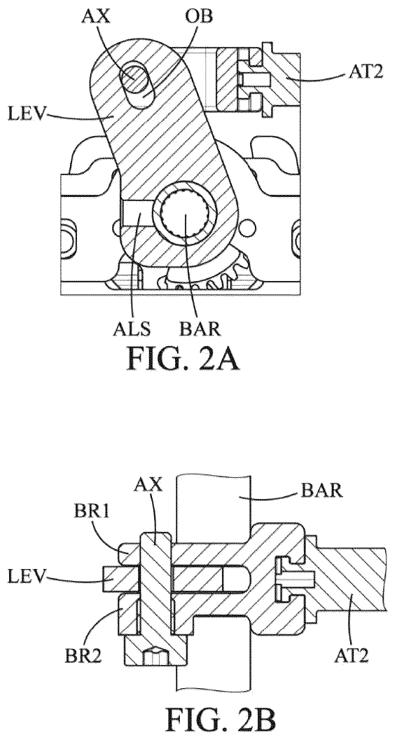

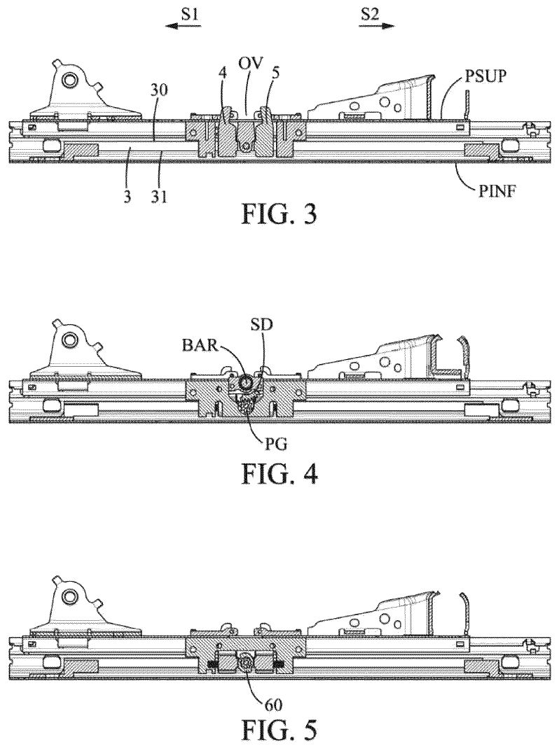

The lever LEV is constrained to rotate with the control bar BAR, the movable part AT2 and the lever LEV being connected by an axis AX rigidly connected to the movable part AT2. This axis AX is configured to move along a limited stroke, within an oblong hole OB of the lever LEV shown by way of example in FIG. 2A, to provide the rotation of the lever relative to the upper profile PSUP of the at least one slide during the translation of the movable part AT2.

As shown in FIG. 2B, the movable part AT2 may have a fork comprising a first branch BR and a second branch BR2 between which the lever LEV is inserted at its distal end. The axis AX connects the first branch BR1 and the second branch BR2, by passing through the oblong hole OB of the lever. The axis typically extends along the transverse direction Y.

The connection between the control bar BAR and the lever LEV may comprise a circumference, in particular a striated one, of the control bar BAR, and a ring BG of the proximal end of the control lever LEV. The ring BG is crossed by the control lever BAR, the ring engaging the circumference of the control bar. The ring BG may comprise a tapped bore ALS for a clamping screw providing the locking of the ring on the control bar.

The control bar BAR can pass through the upper profile PSUP and in particular drive directly a toothed sector SD meshing with a pinion PG, rigidly connected to the unlocking member 60, in particular the rotational unlocking cam. When activated, the actuator AT makes it possible to pivot the control bar around its axis, and thus to pivot the unlocking member 60 in order to provide the separation of the first locking member and the second locking member 5, and thus their switchover to unlocking, and according to the first embodiment of the over-center conditions shown in FIG. 6.

According to the embodiment of FIG. 7, the actuator AT makes it possible, when activated, to pivot the first cam C1 and the second cam C2, in the directions opposite the directions imposed by the first and second resilient means.

The configuration according to FIG. 7 has been the subject of the filing of the patent application FR2205919 which discloses an embodiment of the command to unlock the first cam and the second cam simultaneously moved by a control member, translationally movable along a limited stroke, along a vertical direction Z, relative to the support 7. This control member is configured to switch from a high first rest to a second low position, configured to cause the simultaneous movements of the first cam and the second cam from their positions constrained by the first and second resilient means providing the over-center conditions, to their retracted position, freeing the slide so that it may slide.

To this end, the control member comprises two bearing surfaces simultaneously bearing, on a first stud, projecting from the first cam and a second stud projecting from the second cam, and so as to drive the rotations of the cams in opposite directions.

According to such an embodiment, the vertical movement of the control member, mounted sliding along the vertical direction C relative to the support can be obtained by the rotation of the control bar, by means of a cam system, between the control bar BAR and the control member, in order to transform the rotation of the control bar into a downward translational movement of the control member, which in turn causes the two cams, the first cam C1 and second cam C2, to rotate in opposite directions of rotation.

Advantageously, the system may be configured so that the work provided by the electric actuator AT to provide the switchover of the first and second locking members of the at least one slide to being locked is less than 0.1 joule per slide, in particular less than 0.2 joule to provide the simultaneous switchover of the first and second locking members associated with the first slide 2a and the second slide 2b.

It is thus possible to motorize the system with electric motors that are very low-power and therefore consume little electrical energy.

In particular, the electric actuator AT in particular the electric motor of the actuator can have a nominal power of less than 10 Watts, and in particular a nominal power of less than 5 Watts.

The present disclosure further relates to a vehicle seat comprising a squab and a backrest as well as a continuous-adjustment locking system 1 according to the present disclosure, the first slide element 20 of which is anchored to a floor of the vehicle and the second slide element 21 of which is rigidly connected to a chassis of the squab.

The present disclosure relates to the field of systems for adjusting and locking a slide for a motor vehicle. It relates more particularly to adjustment systems whose slides connect a squab of the seat to the floor of the vehicle. In the present disclosure, a vehicle seat may typically comprise:
a squab, which extends in a direction X, from a front edge and to a rear edge, and extends transversely in a direction Y, from a first lateral edge to a second lateral edge,
a backrest that extends heightwise from the rear edge of the squab, in a direction Z, vertical or inclined typically towards the rear, from a lower edge to an upper edge of the backrest, and extends transversely in a direction Y, from a first lateral edge, to a second lateral edge.

The backrest can be tiltable relative to the squab, typically by a pivot axis between the backrest frame and the squab frame, extending along the transverse direction Y.

The position of the seat in the vehicle can typically be adjusted, along the direction X, by means of an adjustment and locking system according to the present disclosure, or even preferably two adjustment and locking systems, with two slides connecting the squab to the floor of the vehicle.

Thus, the or each of the two slides comprises two slide elements with a first slide element rigidly connected to the floor, typically a lower profile, and a second slide element rigidly connected to the squab of the seat, typically an upper profile, the two slide elements being configured to slide relative to one another in the direction X.

The adjustment and locking system further comprises a locking system, including a control member which is commanded, typically manually or in a motorized fashion, to unlock the slide in order to allow the occupant of the seat to adjust the position of the seat by moving the first slide element, which is movable relative to the second slide element.

Once the position of the seat has been adjusted, the control member is released to lock the seat in adjustment positions corresponding to adjustment steps of the slide.

To this end, comparative locking systems with discontinuous adjustment that have a latch system comprising a support, rigidly connected to the second slide element, and locking members, movable relative to the support, configured to penetrate adjustment openings rigidly connected to the first slide element in a locked state of the latch system, under the action of resilient means such as springs. When actuated, the control member makes it possible to force the locking members against the force of the springs and thus to extract the locking members from the adjustment openings, freeing the slide so that it may slide.

A first family of comparative locking systems sometimes designated “step lock”, for which the locking members, typically rigidly connected to one another, provide the locking of the slide only if the relative position between the two slide elements, the first slide element and second slide element, corresponds to an adjustment step of the slide.

A second family of comparative locking systems with improved safety relative to the first family, sometimes designated “instant lock”, which provides an immobilization of the two elements of the slide, and even if the position between the two slide elements, the first slide element and second slide element, is in any intermediate position between two consecutive adjustment positions.

To this end, the locking members are independent of each other and are configured so that at least one of the members penetrates and becomes immobilized in one of the adjustment openings, which are typically oblong in shape, and even if the slide is in this intermediate position between two adjustment steps, namely two consecutive adjustment positions of the slide.

The slide can then no longer slide over a stroke corresponding to the adjustment step of the slide. A slight sliding of the first slide element relative to the second slide element enables the other locking members that are not penetrating to face the adjustment openings and lock therein when the slide is moved in either of the two consecutive adjustment positions, in order to achieve the locking of the slide. In both cases, whether it is a latch system of the step lock type or the instant lock type, the number of adjustment positions is limited to the number of locking positions permitted by the system's adjustment step.

The present disclosure however relates to the locking slide system with continuous adjustment, namely one that affords an unlimited number of adjustment positions over the length of the slide, and as opposed to the adjustment and locking system described above, with discontinuous adjustment.

Comparative continuous-adjustment locking systems may comprise a rail, rigidly connected to a first fixed part of the slide, rigidly connected to a floor of the vehicle and a locking member pair, including a first locking member and a second locking member rigidly connected to a second movable part of the slide secured to the squab frame of the seat.

In a first relative position between the first locking member and the second locking member, corresponding to the unlocking of the system, the first and second locking member are configured to move freely along the rail, without impediment, allowing the slide to freely slide.

In a second relative position between the first locking member and the second locking member, the following begin to apply on the rail under the over-center conditions that follow, generating:
a first force generated by a first abutment of the second slide part on the first locking member providing an over-center of the first locking member on the rail providing a locking of the second slide element relative to the first slide element in a first sliding direction, by two reactions of the rail on the first locking member, with on the one hand a first reaction between a first upper friction surface of the rail and a first wall of the first friction member and, on the other hand, a second reaction between a second lower friction surface of the rail and a second wall of the first locking member,
a second force generated by the second abutment on the second locking member provides an over-center of the second locking member on the rail providing a locking of the second slide element relative to the first slide element in a second sliding direction, by two reactions of the rail on the second locking member, with on the one hand a third reaction between a first upper friction surface of the rail and the third wall of the second friction member and, on the other hand, a fourth reaction between the second lower friction surface of the rail and the fourth wall of the second locking member.

Such comparative systems may be improved upon by the system of the present disclosure. The present disclosure improves at least all or part of the situation.

A system for locking at least one continuous-adjustment slide for a vehicle seat is proposed, comprising;
the at least one slide, in particular a first slide and a second slide, parallel to each other, the at least one slide, in particular the first slide or the second slide, comprising a first, lower slide element configured to be fastened to a floor of the vehicle, and a second, upper slide element configured to slide along the first slide element
an over-center locking system comprising:
   a rail, extending lengthwise along the at least one slide, fixed relative to the first slide element, the rail having a first, upper friction surface and a second, opposite, lower friction surface
   a first locking member and a second locking member, mounted rigidly connected to the second slide element, with positions offset along a longitudinal axis of the rail, the first locking member comprising a first wall and a second wall, facing each other, configured to rub on the first friction surface and second friction surface of the rail, respectively, the second locking member comprising a third wall and a fourth wall, facing each other, configured to rub on the first friction surface and second friction surface of the rail,
resilient means generating return forces configured to provide:—a switchover to the locking of the first locking member so as to provide an over-center of the first locking member on the rail providing a locking of the second slide element relative to the first slide element in a first sliding direction, by two reactions of the rail on the first locking member, with on the one hand a first reaction between the first upper friction surface of the rail and the first wall of the first locking member and, on the other hand, a second reaction between the second lower friction surface of the rail and the second wall of the first locking member,
   a switchover to the locking of the second locking member providing an over-center of the second locking member on the rail providing a locking of the second slide element relative to the first slide element in a second sliding direction, by two reactions of the rail on the second locking member, with on the one hand a third reaction between a first upper friction surface of the rail and the third wall of the second locking member and, on the other hand, a fourth reaction between the second lower friction surface of the rail and the fourth wall of the second locking member,
an unlocking mechanism which is configured to drive, on the one hand, a switchover to the unlocking of the first locking member releasing the slide so it may slide in the direction S1, and on the other hand, a switchover to the unlocking of the second locking member releasing the slide so it may slide in the direction S2.

According to the present disclosure, the unlocking mechanism comprises an electric actuator and a transmission coupled to the actuator, the electric actuator and the transmission being configured to provide the switchover of the first locking member and the switchover to the unlocking of the second locking member, against the return forces of the resilient means.

The features disclosed in the following paragraphs may optionally be implemented. They can be implemented independently of one another or in combination with one another:
the first slide element is a lower profile and the second slide element is an upper profile, slidably mounted along the lower profile, the first locking member and the second locking member extending internally in the interspace between the upper profile and the lower profile, the rail rigidly connected to the lower profile, accommodated in the interspace, and if necessary the first locking member (and the second locking member protrudes from the upper profile through at least one opening of the upper profile;
the electric actuator is embedded on the movable upper profile, outside the interspace between the upper profile and the lower profile, preferably the lower profile having a section with a base extending substantially along a plane parallel to the plane XY, extended by one or even two upward wings and the upper profile, having a section, with a main wing extending substantially along a plane parallel to the plane XY, extended by two downward wings and wherein the electric actuator is arranged above the main wing;
the electric actuator comprises a first part fixed relative to the upper profile and a part translationally movable relative to the fixed part, connected to the transmission, and wherein the movable part is translationally movable in a direction which is, for example, parallel to the sliding direction of the slide, or a direction inclined relative to the sliding direction, for example by plus or minus 15°, in particular around a transverse direction Y;
the transmission comprises a control bar, rigidly connected to the upper slide profile of the at least one slide, rotatably mounted about an axis of rotation of the control bar in a direction Y transverse to the at least one slide, preferably the control bar (BAR) connecting the upper profiles (of the two slides by synchronizing the unlocking of the first locking member and of the second internal locking member, both within the interspace of the upper and lower profiles of the first slide, on the one hand, and the unlocking of the first locking member and of the second internal locking member, both within the interspace of the upper and lower profiles of the second slide, on the other hand, when the at least one slide comprises the two slides consisting of the first slide and the second slide;
the translationally movable part of the electric actuator is connected to the control bar by means of a lever extending radially to the control bar, the lever constrained to rotate with the control bar, the movable part and the lever being connected by an axis rigidly connected to the movable part, configured to move along a limited stroke, within an oblong hole of the lever, to provide the rotation of the lever relative to the upper profile of the at least one slide during the translation of the movable part;
the movable part having a fork comprising a first branch and a second branch between which the lever is inserted, the axis connecting the first branch and the second branch, passing through the oblong hole of the lever;
the at least one slide comprises the first slide and the second slide, the control connecting the upper profiles of the two slides by synchronizing the unlocking of the first and second locking members within the interspace of the upper and lower profiles of the first slide, on the one hand, and the unlocking of the first and second locking members within the interspace of the upper and lower profiles of the second slide, on the other hand, the actuator being a single actuator rigidly connected to the upper profile of the first slide or rigidly connected to the second slide configured to provide the unlocking of the locking members of the two slides consisting of the first slide and second slide via the control bar;
the system is configured so that the work provided by the electric actuator to provide the switchover of the first and second locking members of the at least one slide to being locked is less than 0.1 joule per slide, in particular less than 0.2 joule to provide the simultaneous switchover of the first and second locking members associated with the first slide and the second slide. This allows the use of an actuator that is not very powerful, for example a rated power of less than 10 watts, or even rated power less than 5 watts.

According to a second aspect, the present disclosure relates to a vehicle seat comprising a squab and a backrest as well as a continuous-adjustment locking system according to the present disclosure, the first slide element of which is anchored to a floor of the vehicle and the second slide element of which is rigidly connected to a chassis of the squab.

A system (1) for locking at least one continuous-adjustment slide for a vehicle seat, comprising;
the at least one slide (2),
an over-center locking system comprising:
   a rail, fixed relative to the first slide element,
   resilient means generating return forces configured to provide a switchover to locking of a first locking member so as to provide an over-center of the first locking member on the rail (3) and a switchover to locking of a second locking member (5) providing an over-center of the second locking member on the rail (3)

According to the present disclosure, an unlocking mechanism comprises an electric actuator (AT) and a transmission (TR) configured to provide the switchover to unlocking of the first locking member (4) and the switchover (5) to unlocking of the second locking member, against the return forces of the resilient means.

1. A system for locking at least one continuous-adjustment slide for a vehicle seat, comprising;
the at least one slide, in particular a first slide and a second slide, parallel to each other, the at least one slide, in particular the first slide or the second slide, comprising a first, lower slide element configured to be fastened to a floor of the vehicle, and a second, upper slide element configured to slide along the first slide element
an over-center locking system comprising:
a rail, extending lengthwise along the at least one slide, fixed relative to the first slide element, the rail having a first, upper friction surface and a second, opposite, lower friction surface,
a first locking member and a second locking member, mounted rigidly connected to the second slide element, with positions offset along a longitudinal axis of the rail, the first locking member comprising a first wall and a second wall, facing each other, configured to rub on the first friction surface and second friction surface of the rail, respectively, the second locking member comprising a third wall and a fourth wall, facing each other, configured to rub on the first friction surface and second friction surface of the rail,
resilient means generating return forces configured to provide:
a switchover to the locking of the first locking member so as to provide an over-center of the first locking member on the rail providing a locking of the second slide element relative to the first slide element in a first sliding direction, by two reactions of the rail on the first locking member, with on the one hand a first reaction between the first upper friction surface of the rail and the first wall of the first locking member and, on the other hand, a second reaction between the second lower friction surface of the rail and the second wall of the first locking member,
a switchover to the locking of the second locking member providing an over-center of the second locking member on the rail providing a locking of the second slide element relative to the first slide element in a second sliding direction, by two reactions of the rail on the second locking member, with on the one hand a third reaction between the first upper friction surface of the rail and the third wall of the second locking member and, on the other hand, a fourth reaction between the second lower friction surface of the rail and the fourth wall of the second locking member,
an unlocking mechanism which is configured to drive, on the one hand, a switchover to the unlocking of the first locking member releasing the slide so it may slide in the direction, and on the other hand, a switchover to the unlocking of the second locking member releasing the slide so it may slide in the direction,
wherein the unlocking mechanism comprises an electric actuator and a transmission coupled to the actuator, the electric actuator and the transmission being configured to provide the switchover of the first locking member and the switchover to the unlocking of the second locking member, against the return forces of the resilient means.

2. The system of claim 1, wherein the first slide element is a lower profile and the second slide element is an upper profile, slidably mounted along the lower profile, the first locking member and the second locking member extending internally in the interspace between the upper profile and the lower profile, the rail rigidly connected to the lower profile, accommodated in the interspace, and if necessary the first locking member and the second locking member protrudes from the upper profile through at least one opening of the upper profile.

3. The system of claim 2, wherein the electric actuator is embedded on the movable upper profile, outside the interspace between the upper profile and the lower profile, preferably the lower profile having a section with a base extending substantially along a plane parallel to the plane XY, extended by one or even two upward wings and the upper profile, having a section, with a main wing extending substantially along a plane parallel to the plane XY, extended by two downward wings and wherein the electric actuator is arranged above the main wing.

4. The system of claim 3, wherein the electric actuator comprises a first part fixed relative to the upper profile and a part translationally movable relative to the fixed part, connected to the transmission, and wherein the movable part is translationally movable in a direction which is, for example, parallel to the sliding direction of the slide, or a direction inclined relative to the sliding direction, for example by plus or minus 15°, in particular around a transverse direction.

5. The system of claim 4, wherein the transmission comprises a control bar, rigidly connected to the upper slide profile of the at least one slide, rotatably mounted about an axis of rotation of the control bar in a direction Y transverse to the at least one slide, preferably the control bar connecting the upper profiles of the two slides by synchronizing the unlocking of the first locking member and of the second locking member, both within the interspace of the upper and lower profiles of the first slide, on the one hand, and the unlocking of the first locking member and of the second locking member both within the interspace of the upper and lower profiles of the second slide, on the other hand, when the at least one slide comprises the two slides consisting of the first slide and the second slide.

6. The system of claim 5, wherein the translationally movable part of the electric actuator is connected to the control bar by means of a lever extending radially to the control bar, the lever constrained to rotate with the control bar, the movable part and the lever being connected by an axis rigidly connected to the movable part, configured to move along a limited stroke, within an oblong hole of the lever, to provide the rotation of the lever relative to the upper profile of the at least one slide during the translation of the movable part.

7. The system of claim 6, wherein the movable part having a fork comprising a first branch and a second branch between which the lever is inserted, the axis connecting the first branch and the second branch, by passing through the oblong hole of the lever.

8. The system of claim 5, wherein the at least one slide comprises the first slide and the second slide, the control connecting the upper profiles of the two slides by synchronizing the unlocking of the first and second locking members within the interspace of the upper and lower profiles of the first slide, on the one hand, and the unlocking of the first and second locking members within the interspace of the upper and lower profiles of the second slide, on the other hand, the actuator being a single actuator rigidly connected to the upper profile of the first slide or rigidly connected to the second slide configured to provide the unlocking of the locking members of the two slides consisting of the first slide and second slide via the control bar.

9. The system of claim 1, configured so that the work provided by the electric actuator to provide the switchover of the first and second locking members of the at least one slide to being locked is less than 0.1 joule per slide, in particular less than 0.2 joule to provide the simultaneous switchover of the first and second locking members associated with the first slide and the second slide.

10. A vehicle seat comprising a squab and a backrest as well as the system of claim 1, wherein the first slide element of which is anchored to a floor of the vehicle and the second slide element of which is rigidly connected to a frame of the squab.
